(19) United States
(12) Patent Application Publication
(10) Pub. No.: US 2017/0187109 A1
(43) Pub. Date: Jun. 29, 2017

(54) Final fabrication and calibration steps for hierarchically elaborated phased-array antenna and subarray manufacturing process

(71) Applicants: James June-Ming Wang, Pasadena, CA (US); Chak-Ming Chie, Culver City, CA (US); Hamed Alsuraisry, Riyadh (SA); Saleh Alsaif, Riyahd (SA); Abdulelah Alshehri, Riyahd (SE)

(72) Inventors: James June-Ming Wang, Pasadena, CA (US); Chak-Ming Chie, Culver City, CA (US); Hamed Alsuraisry, Riyadh (SA); Saleh Alsaif, Riyahd (SA); Abdulelah Alshehri, Riyahd (SE)

(21) Appl. No.: 15/217,992

(22) Filed: Jul. 23, 2016

Related U.S. Application Data
(63) Continuation-in-part of application No. 14/983,293, filed on Dec. 29, 2015.

(51) Int. Cl. H01Q 3/26; H01Q 3/36; H01Q 5/55

(52) U.S. Cl. CPC H01Q 3/267; H01Q 5/55; H01Q 3/36

(57) ABSTRACT

A process writes phase shift error correction values into a phased-array antenna to normalize a range of manufacturing variances. An axial ratio is determined for an antenna weight vector (AWV) by making multiple measurements with the horn of a test antenna mechanically rotating from 0 to 180 degree or with dual polarization test antenna. For calibration of the whole array, each subarray is treated in the same fashion as equivalent to an antenna element in the subarray calibration. The subarray is electronically rotated as a whole (all elements rotated by the same phase shift value) from 0 to 360 degree during the full array calibration. Due to small power variation among AWVs, calibration solely by REV results fail to consistently converge to resolution. Accordingly, the apparatus measures and compares axial ratios. During final fabrication, the apparatus programs an AWV with best axial ratio into each non-transitory array element.

### CROSS-REFERENCES TO RELATED APPLICATIONS

The present invention is a continuation in part application of currently pending Ser. No. 14/983,293 filed Dec. 12, 2015 which is incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

STATEMENT REGARDING PRIOR DISCLOSURES BY THE INVENTOR OR A JOINT INVENTOR

Not Applicable

### BACKGROUND OF THE INVENTION

Technical Field

The invention concerns a steerable beam antenna system using a phased-array of planar elements operating on several dissimilar frequencies or wavelengths.

Description of the Related Art

One related art for calibration of phased-array antennas is known as the REV method. It has limitations however for arrays beyond a small number of antenna elements such as a hierarchically elaborated solid state multi-layer fabrication.

In a phased-array module with transmit and receive capabilities, it is desirable to have transmit beam aligned with receiver beam precisely. When the array antenna size is bigger, the beamwidth of the antenna beam is smaller and the required precision of alignment increases.

As is known, Phased array antenna (PAA) calibration is the process of determining the PAA channel characteristics; these characteristics are used in beam forming algorithms. In “contactless” PAA calibration methods, measurements are made by a stationary probe antenna placed away from the tested antenna, and the channel characteristics are determined from the measured data. Two of these methods are the MTE and REV methods, based on power only measurements. The MTE and REV calibration methods are described by Shitikov et al. Antenna Theory and Techniques, 2003. 4th International Conference on (Volume: 761-764 vol. 2).

As is known in the field of phased-array antennas, when the number of elements in an subarray is not large, the REV method can be used. Phased Array Antenna Calibration . . . -REV Method, Chiba, Kumagae, Yonezawa, Hariu, and Morita, Mitsubishi Electric. Japan Aerospace Exploration Agency 1985 EORC-061/data/f_papers/ceos085.pdf

The REV method varies the phase of individual antenna element from 0 to 360 degrees.

For transmit array calibration, the power received in the gain horn is recorded as a function of phase shifter values. For receive array calibration, the power received by the antenna under test is recorded as a function of the phase shifter values.

REV finds phase and amplitude error of each antenna element I by rotating the phase shift of each element, whereby a min and max ratio and angle to achieve max can be measured.

The phase shift corresponding to maximum power is the phase error of individual antenna element.

### Explanation of REV Method

Maximum efficiency occurs when a correction phase −Δ0 is added to phase shifter). The process finds the magnitude of Ei versus of magnitude E0 (K parameter). The process finds the phase error (X parameter) for each element I. The corrections are stored.

An exemplary iterative calibration method consists of first breaking up an array into a plurality of smaller subarrays and calibrating each subarray with REV method for a given beam direction. i.e. by rotating phase shift of each antenna element from 0 to 360 degree and finding the max power and the corresponding phase shift. After updating the phase shift values of all antenna elements, continuing to iterate the subarray with the same procedure. It was the expectation that after a few iterations, the phase from all antenna elements in the subarray would be approximately aligned. With finite phase shift resolution, the calibrated results will be moving around an optimal point. Sadly, it has now been observed that it is hard to find accurate optimal point (set of phase shift values) with conventional REV method applied to non-trivial numbers of elements.

As it turns out, in an array of antenna elements, when the phase of one element is changed, the combined vector becomes shifted as well. In the case of a large number of elements (combined vector is stable statistically), test resolution is very bad (say 1 out of 1000). It converges quickly to a stable solution, but it is very hard to measure effects of one out of 1000. Alternately, a small number of elements results in measurable but instable solutions.

What is needed is a way to calibrate and manufacture large phased-array antennas in a scalable way.

In a typical user terminal designed for mobility, the phased array antenna scans its field of view to find the incoming signal from the transmitter of a remote terminal or hub. When the receive antenna beam points to the correct direction, the incoming signal is received with high signal strength and demodulated. From the demodulated and decoded signal, the receiver acquires the proper status of the system operation and obtains some time window for its transmission. If the transmit antenna beam is aligned with the receive antenna beam, the signal transmission by the user terminal at the allowable time window of transmission can reach the remote terminal at proper strength (i.e., transmit signal toward the remote terminal enhanced with the high antenna gain) to allow the receiver of the remote terminal to process immediately.

If the transmit beam is poorly aligned with the receive beam in the phased-array antenna of the user terminal, a transmit beam training operation is performed in which the transmitter scans its signal across the region of the remote terminal to allow the remote terminal to acquire the signal at a local maximum. The remote terminal needs to feedback the status once it acquires the signal. Obviously, this operation is significantly more complex than the case in which a transmit beam is aligned with the receive beam.

When the phased-array antenna is being calibrated (the operation of aligning the transmit beam to the receive beam), the transmit antenna weight vector (AWV) is changed until the transmit beam precisely points to the same direction as the receive beam. This is usually performed within an anechoic chamber with a test antenna (which contains TX and RX) and the array antenna to be calibrated positioned at opposite sides of the chamber. The test antenna first transmits a signal to allow the phased-array antenna receive beam to adjust until peak power is received (meaning the receiver beam of the phased-array antenna is pointing at the test antenna direction). The phased-array antenna then transmits using different antenna beams (AWVs) until the test antenna received power is peaking. Note that in theory the AWV can be calculated mathematically based on the required phase shift values of each antenna element for a beam direction to compensate for different signal delays at antenna elements. However, in practice, due to hardware implementation imperfection, coupling in signal path for each antenna element within hardware, inaccuracies of implementations, physical misalignment, the mathematically generated AWV does not necessarily provide accurate alignment between transmit beam and receive beam.

There are a large number of AWVs (beams) in a large phased-array antenna. A phased-array antenna with n antenna elements has n phase shifters. If the phase shifter has 2̂k steps (a k-bit phase shifter), the number of possible AWVs would be 2̂k*n). A brute-force calibration going through 2̂k*n) AWVs can take an extremely long time. Hence there is a need for a novel procedure to simplify the number of calibration states.

In principle, only a subset of receive antenna beam are needed. For example, if the beamwidth of an antenna of interest is 2 degrees, the subset of antenna beams and its corresponding AWVs which are separated by 1 degree in pointing angle would be sufficient. The subset would cover the FoV with 1 degree beam step. This subset with 1 degree granularity is sufficient in practical operation. Smaller granularity requires a larger set of beams. The subset of AWVs is called codebook and the receiver beam points to each different direction by using an AWV within the codebook. The calibration of transmit beam is performed over each of the receive beam within the codebook.

A conventional phased-array antenna enables a highly directive antenna beam to be steered toward a single certain direction. The direction of an antenna beam may be controlled by setting the phase shifts of each of the antenna elements in the array.

Steerable single frequency phased-array antennas are known. Low Temperature Co-fired Ceramic (LTCC) devices are known. LTCC technology is especially beneficial for RF and high-frequency applications. In RF and wireless applications, LTCC technology is also used to produce multilayer hybrid integrated circuits, which can include resistors, inductors, capacitors, and active components in the same package. There are a number of similar low loss RF and high frequency substrates such as Rogers, Teflon, and Megtron 6, which are suitable for multilayer construction.

As is known, a planar antenna using layer substrate or LTCC (low temperature co-fired ceramic) or similar substrate material can be constructed using printed circuit board techniques.

As is known, a planar phased-array antenna consists of a number of antenna elements, deployed on a planar surface. Incoming planar waveforms arrive at different antenna elements of a receive phased-array antenna at different delays. These delays are conventionally compensated with phase shifts before the signals are combined. Conversely, a transmit array consists of a number of antenna elements on a planar surface, and the signals for these elements are phased shifted before they are transmitted to compensate for signal delay toward a certain direction.

$$F ( cos {α}_{xs} , cos {α}_{ys} ) = {\sum }_{m = 0}^{M - 1} {\sum }_{n = 0}^{N - 1} \vert {A}_{mn} \vert {e}^{j [ m \frac{2 π}{λ} dx ( cos {α}_{x} - cos {α}_{xs} ) + n \frac{2 π}{λ} dy ( cos {α}_{y} - cos {α}_{ys} ) ]}$$

It is desirable to have a smooth element pattern which covers the array field of view (FoV).

For a planar phased-array antenna with antenna elements deployed with regular spacing in a grid, the spacing between adjacent elements must be less than a certain value, determined by its scanning angle, to prevent grating lobes.

Furthermore, the dimension of the antennas on a substrate may be optimized by the thickness of the substrate which would be desirably proportional to the wavelength or the inverse of the operating frequency.

### BRIEF SUMMARY OF THE INVENTION

A hierarchically elaborated phased-array antenna is calibrated by hierarchically determining and programming phase-error corrections.

A calibration and fabrication apparatus for a large phased-array antenna comprises: a test antenna (horn) coupled to a 1st radio-frequency transceiver, the transceiver coupled to a 1st power level instrument, the power level instrument coupled to a computing device; the computing device further coupled to an antenna weight vector programming device, the programming device further coupled to a phased-array antenna test fixture; the test fixture further coupled to a 2nd radio-frequency transceiver and a 2nd power level instrument. In an embodiment at least one of the horn and the test fixture are rotationally measureable and operable by the computing device. The apparatus sorts arrays by power level after programming and fails an array when it measures power level below a threshold.

Upon completion, a process writes high resolution phase shift correction values into non-transitory storage elements of a large phased-array antenna. These values correspond to Phase Error corrections which cause individual elements of the array to avoid interference with other elements and maximize the transmitted or received radiation power. The process is a manufacturing step to correct for individual variances from the ideal design of an array. The process transforms a raw array into a finished good suitable for an end-user.

The axial ratio is determined for an antenna weight vector (AWV) by making multiple measurements with the horn of a test antenna rotating on a bearing from 0 to 180 degree. For each iteration of an AWV, its axial ratio is calculated. A minimal axial ratio is understood to correspond to the highest density for multiple AWVs having received power levels within a narrow range. Thus, among AWVs having nearly equivalent received power levels, higher resolution is preferred and consequently selected by the criteria of minimizing axial ratio.

For calibration of the whole array, each subarray is treated in the same fashion as equivalent to an antenna element in the subarray calibration. The subarrays are rotated as a whole (all elements in subarray rotated by adding the same phase shift value) from 0 to 360 degree during the full array calibration. Once a subarray has been optimized it can be swept through a range by adding an identical increment of phase angle to every element of the subarray. The process is reentrant and applies to subsets of subarrays in hierarchical fashion.

REV-calibration results alone cannot resolve due to small power variation among AWVs. Accordingly, the axial ratios are measured and compared. The AWV with best axial ratio is programmed into each non-transitory array element during final fabrication. Axial Ratio (AR) scoring provides an exit mechanism for each REV-calibration and hierarchical calibration enables REV plus AR to economically scale to large arrays.

A transmit beam is calibrated from strengths of a plurality of beams recorded from a test horn.

A loss/gain through the phase shifter is equalized with a variable gain amplifier for each phase shifter state. Thus, all phase shifter+ variable gain amplifier states have the same loss/gain value.

Step 1: Break up the antenna into L receive subarrays, and the corresponding L transmit subarrays. Preferably, L receiver sub-arrays are of substantially equal size and the corresponding L transmit subarray are of equal size. The number of phase shifters in a subarray is sufficiently small to facilitate calibration.

Step 2: Note that in the test setup for determining the receive codebook, the antenna under test is placed on a precision mechanically rotatable platform for adjustment of antenna orientation. In the test setup for determining the receive codebook, the mechanical platform is adjusted to the given receive beam direction and the receive beam is pointed by peaking the array received power from the test horn. From this the AWV of the receive beam direction is selected from a pre-determined procedure and stored in the receive AWV codebook.) Within Step 2, several embodiments can be employed to calibrate the corresponding transmit subarray. Once the receive beam of sub-array is selected, the same procedure is used for the transmit sub-array.

Step 3: A receive beam of the bigger subarray is formed from the combined corresponding transmit sub-array AWV. A quick search among the AWVs from the calibrated transmit subarray in small perturbed direction around the intended direction can be conducted to see if the received signal strength of the test horn can be increased. This way the receive beam of a bigger subarray is calibrated. The same procedure is applied to the corresponding bigger transmit subarray.

Step 4: The process of Step 3 is repeated for incrementally bigger sub-array until the entire array is calibrated.

A method to reduce the calibration steps of a transmit antenna is disclosed in detail.

The method applies to planar phased-array antenna as follows:

An efficient phase calibration scheme for a phased-array antenna consisting of a number of small submodules (subarrays) is disclosed. Each submodule (subarray) has a digital interface and contains a number of antenna elements and the associated phase shifters. The disclosed phase control scheme requires dissemination of minimum amount of phase control information to the submodules.

An array of registers local to each antenna element of a phased-array antenna contains phase shifter and gain equalizer values. Receiving an address, position, or location within the register array from a directional beam controller determines a beam direction. These values can be preloaded and a specific set of phase shifter and gain equalizer values corresponding to a beam direction indicated by disseminating a pointer. Alternatively, a digital functional logic circuit for each antenna element can determine the required phase shift on the fly by receiving a phase increment broadcast to every antenna element.

An apparatus is configured to efficiently elaborate phase shift weights into a submodule of a phased-array antenna system. Each subarray phase control submodule is uniquely configured to receive and elaborate weights for a submodule of elements to control phase shifters. Major operators and minor operators are received and transformed by an apparatus coupled to a phased-array antenna suitable for a high mobility device. Each submodule determines its own base phase shift weight per its unique configuration. A recursive adder or multiplier applies phase increments to direct an antenna beam by controlling elements within an array subset.

A phased-array antenna panel is constructed from building blocks. These are a plurality of front end modules, mounted to a Printed Circuit Board (PCB).

Each front end module has a plurality of antenna elements coupled to a frontend die. The frontend die is coupled to a phased-array processing die.

A customized and customizable Radio Frequency Integrated Circuit (RFIC) device includes: phased-array processing blocks; phase-shifters, combiners, splitters, gain equalizers, buffer amplifiers, and a digital signal control and interface circuit.

A register array in each RFIC is grouped into a local register group and a central register group, the local registers physically placed close in proximity to RF chains which each correspond to an element of array antenna, whereby each set of local registers control an individual antenna element and a central register controlling overall RFIC function.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B are flowcharts of a method of calibration; FIG. 2 illustrates a test configuration; FIG. 3 shows a circuit schematic of an array and power as a function of phase variation; and FIG. 4 is a flowchart of method steps.

### DETAILED DISCLOSURE OF EMBODIMENTS OF THE INVENTION

Conventional calibration methods are augmented by measuring the antenna aspect ratio. The lower value of the ratio is taken as a figure of merit and criteria for selection of error corrections to an AWV.

The invention includes an apparatus to improve calibration and efficient manufacture of large phased-array antennas.

The apparatus performs a Method of Subarray and Array Antenna Calibration. The method decomposes a large array into a hierarchy of subarrays and, if necessary, further decomposes each subarray to process a number of antenna components suitable for computational and resource capacity. Non-limiting exemplary components include 4×4 subarrays in a module or 4×4 antenna elements in a subarray. One exemplary large phased-array antenna could include a plurality of modules, or a plurality of subarrays. The principle of the invention extends to antennas with even more hierarchical levels.

Subarray Calibration is a Technique to improve calibration by the following invention:

The invention to improve calibration is to measure the axial ratio. The axial ratio (AR, which is the cross-polarization) of the test antenna can be measured by making multiple measurements with the horn antenna rotating from 0 to 180 degree.

On each REV iteration, measure the AR. When REV is near convergence, pick the best AR results to improve the resolution of REV method.

### Improved Subarray Calibration

For an antenna under test with linear polarization, a linear polarized horn antenna is used and the antenna axial ratio can be observed by comparing measurements when the horn antenna is rotated from 0 to 180 degree. Note that the ratio of maximum power versus minimum power (observe at 90 degree angle difference) is an indication of axial ratio. The larger the ratio, the better the axial ratio.

For antenna under test with circular polarization, a circular horn antenna can be used (alternatively, the axial ratio of the circular polarization results can be derived from a linear horn antenna).

Once REV method is converged to a certain degree and the power variation in an iteration is small (since phase error is small). The antenna axial ratio is then also measured in the subsequent iterations. Note that when multiple REV iteration results yield a small power variation (max and min power within a pre-determined range), the axial ratios of these iterations are measured and compared. The iteration corresponds to the best axial ratio is selected as the results of the calibration.

This method improves the resolution of the REV method to obtain more accurate phase shifter (or antenna weight vector) values.

### Whole Antenna Array Calibration

The subarray calibration results are not changed when all antenna element are rotated the same amount of phase shift value. The only thing matter is the relative phase shift values between elements.

For calibration of the whole array, each subarray is treated in the same fashion as equivalent to an antenna element in the subarray calibration. The subarray are rotated as a whole (all elements in subarray rotate the same phase shift value). from 0 to 360 degree during the full array calibration.

The received power is recorded as a function of the subarray phase shift. The phase shift error corresponding to the phase shift value at the maximum power level.

Note that the number of sub-arrays in the whole array should not be too large. If the number of sub-array is too large, REV method will not be accurate. In this case, a second tier of sub-array should be used. For example, if number of sub-arrays in the whole array is 128. We should start with a second tier subarray consists of 16 sub-array and calibrate the second tier subarray one by one. After that we calibrate the whole array consisting of 8 second tier subarray.

Once REV method for the whole array is converged to a certain degree and the power variation in an iteration is small. The antenna axial ratio of the whole array is then also measured in the subsequent iterations. Note that when multiple REV iteration results yield a small power variation (max and min power within a pre-determined range), the axial ratios of these iterations are measured and compared. The iteration corresponds to the best axial ratio is selected as the results of the calibration.

This method improves the resolution of the REV method to obtain more accurate phase shifter (or antenna weight vector) values.

TX AuT (Antenna under Test) Procedure-1

Step 1: Break up array into N tier 1 subarray, each tier 1 subarray with n1 antenna element (e.g., n1=16, arrange in 4×4 consecutive element configuration). Note that the number of antenna elements in the tier 1 subarray should be<a predetermined number.

Step 2 for one beam steering angle θj, j belongs in {0, 1, . . . , (L-1)} (Note θj can be in azimuth or elevation direction), for each j, rotate AuT platform such that beam steering direction points toward test horn.

### Step 3 Calibration of N Subarrays

Step 3.1 for subarrayi, i=0, 1, . . . , (N-1), Step 3.1.1 Perform a few iterations of the following steps until (maximum received power-minimum received) averaged over n1 of Step 2.1.2.3 is less than δ1: Step 3.1.1.1: Load AWV for intended beam steering direction (start with initial AWV); Step 3.1.1.2: Rotate phase shifter of kth antenna element within the subarray by increment 0 to 180 degree in pre-determined step, and measure the corresponding received power and antenna axial ratio. Record the Δ phase shift value corresponding to the maximum received power.

Step 3.1.1.3 Repeat the preceding step for k=0, 1, . . . , (n1-1) antenna element; Step 3.1.1.4 Correct AWV by the recorded Δ phase shift values corresponding to the maximum received power for all antenna elements within the subarray; Step 3.1.2 Continue Step 2.1.2 for a few iterations and select the AWV which gives the smallest AR as the AWV for beam direction θj.

Step 4 Break up array into M tier 2 subarrays, each tier 2 subarray contains with n2 of tier 1 subarrays (e.g., n2=16, arrange in 4×4 consecutive tier 1 subarray configuration). Note that the number of tier 1 subarrays within tier 2 subarray should be<a predetermined number.

Step 5 Calibration of M tier 2 Subarrays

Step 5.1 for tier 2 subarrayi, i=0, 1, . . . , (M-1), Step 5.1.1 Perform a few iterations of the following steps until (maximum received power-minimum received) averaged over n2 of Step 2.1.2.3 is less than δ2:

Step 5.1.1.1: Load AWV for intended beam steering direction (start with initial AWV); Step 5.1.1.2: Rotate phase shifter of kth tier 1 subarray with all antenna element with the subarray rotate the same amount of phase shift by increment 0 to 180 degree in pre-determined step, and measure the corresponding received power and antenna axial ratio. Record the Δ phase shift value corresponding to the maximum received power.

Step 5.1.1.3 Repeat the preceding step for k=0, 1, . . . , (n2-1) tier 1 subarray.

Step 5.1.1.4 Correct AWV of all antenna elements in all subarrays by the recorded Δ phase shift value corresponding to the maximum received power for each tier 1 subarray within the tier 2 subarray; Step 5.1.2 Continue Step 4.1.2 for a few iterations and select the AWV which gives the smallest AR as the AWV for beam direction θj.

Step 6 If the number of tier x subarrays within tier x+1 subarray should be<a predetermined number, continue to break up array into tier x+2 subarrays, if necessary and repeat Step 3 to 5 to calibrate x+1 tier subarrays.

Repeat Step 3 to Step 6 for other θj's.

TX AuT (Antenna under Test) Procedure-Alt 1

Step 1: Break up array into N tier 1 subarray, each tier 1 subarray with n1 antenna element (e.g., n1 =16, arrange in 4×4 consecutive element configuration). Note that the number of antenna elements in the tier 1 subarray should be<a predetermined number.

Step 2 for one beam steering angle θj, j belongs in {0, 1, . . . , (L-1)} (Note θj can be in azimuth or elevation direction), for each j, rotate AuT platform such that beam steering direction points toward test horn.

### Step 3 Calibration of N Subarrays

Step 3.1 for subarrayi, i=0, 1, . . . , (N-1), Step 3.1.1 Perform a few iterations of the following steps until (maximum received power-minimum received) averaged over n1 of Step 2.1.2.3 is less than δ1: Step 3.1.1.1: Load AWV for intended beam steering direction (start with initial AWV); Step 3.1.1.2: Rotate phase shifter of kth antenna element within the subarray by increment 0 to 180 degree in pre-determined step, and measure the corresponding received power and antenna axial ratio. Record the Δ phase shift value corresponding to the maximum received power. Step 3.1.1.3 Correct AWV by the record Δ phase shift value corresponding to the maximum received power for kth antenna element within the subarray; Step 3.1.1.4 Repeat the preceding step for k=0, 1, . . . , (n1 -1) antenna element. Step 3.1.2 Continue Step 2.1.2 for a few iterations and select the AWV which gives the smallest AR as the AWV for beam direction θj.

Step 4 Break up array into M tier 2 subarrays, each tier 2 subarray contains with n2 of tier 1 subarrays (e.g., n2=16, arrange in 4×4 consecutive tier 1 subarray configuration). Note that the number of tier 1 subarrays within tier 2 subarray should be<a predetermined number.

### Step 5 Calibration of M Tier 2 Subarrays

Step 5.1 for tier 2 subarrayi, i=0, 1, . . . , (M-1), Step 5.1.1 Perform a few iterations of the following steps until (maximum received power-minimum received) averaged over n2 of Step 2.1.2.3 is less than δ2: Step 5.1.1.1: Load AWV for intended beam steering direction (start with initial AWV); Step 5.1.1.2: Rotate phase shifter of kth tier 1 subarray with all antenna element with the subarray rotate the same amount of phase shift by increment 0 to 180 degree in pre-determined step, and measure the corresponding received power and antenna axial ratio. Record the Δ phase shift value corresponding to the maximum received power.

Step 5.1.1.3 Correct AWV of all antenna elements in kth subarray by the record Δ phase shift value corresponding to the maximum received power for each tier 1 subarray within the tier 2 subarray.

Step 5.1.1.4 Repeat the preceding step for k=0, 1, . . . , (n2-1) tier 1 subarray.

Step 5.1.2 Continue Step 4.1.2 for a few iterations and select the AWV which gives the smallest AR as the AWV for beam direction θj.

### TX AuT (Antenna Under Test) Procedure-Alt 3

Step 6 If the number of tier x subarrays within tier x+1 subarray subarray should be<a predetermined number, continue to break up array into tier x+2 subarrays, if necessary and repeat Step 3 to 5 to calibrate x+1 tier subarrays.

Repeat Step 3 to Step 6 for other θj's.

### RX AuT (Antenna Under Test) Procedure

Same as above procedure, except test horn transmit and AuT receive.

One aspect of the invention is a method for calibrating and manufacturing a phased-array antenna which includes:

Transmitting a test signal from a test antenna horn to a phased-array antenna under test; Partitioning a plurality of antenna elements of the phased-array antenna into a plurality of stagel subarrays; transmitting a test signal from a test antenna horn; at each stagel subarray, performing AR-enhanced REV-calibration; grouping stagel subarrays into a plurality of stage2 subarrays on the condition that the phased-array antenna has more than a level1 of antenna elements; at each stage2 subarray, performing AR-enhanced REV-calibration; grouping stage 2 subarrays into a plurality of stage 3 subarrays on the condition that the phased-array antenna has more than a level2 of antenna elements; at each stage3 subarray, performing AR-enhanced REV-calibration;writing into non-transitory storage Phase error values determined by AR-enhanced REV-calibration, and transmitting a test signal from the phased-array antenna to the test antenna horn.

In an embodiment, AR-enhanced REV-calibration includes: applying REV-method calibration to each element of the stagel subarray until received power level is not improving, upon determining that received power level at the stagel subarray has started wandering, initiating axial ratio (AR) selection for each REV-method calibration; storing an antenna weight value resulting from REV-method calibration having best AR into a store for each stagel subarray.

In an embodiment, REV-calibration includes: the REV method varies the phase of individual antenna element from 0 to 360 degree.

For transmit array calibration, the power received in the gain horn is recorded as a function of phase shifter values.

For receive array calibration, the power received by the antenna under test is recorded as a function of the phase shifter values.

Find phase and amplitude error of element I by rotating the phase shift of each element, a min and max ratio and angle to achieve max can be measured.

The phase shift corresponding to maximum power is the phase error of individual antenna element.

### Iterative Calibration Method

For a large array, first break up into smaller subarray and calibrate each subarray with ReV method described for a given beam direction.

Rotate phase shift of each antenna element from 0 to 360 degree and find the max power and the corresponding phase shift.

Update the phase shift values of all antenna elements.

A hierarchical method of calibration simplifies fabrication of a large phased-array antenna. Step 1: Break up the antenna into L receive subarrays, and the corresponding L transmit subarrays. Note that the size of the receive subarray in proportional to the whole receive array is roughly equal to the size of the corresponding transmit subarray in proportional to the whole transmit array. Preferably, L receiver sub-arrays are of equal size and the corresponding L transmit subarray are of equal size. The sub-array is of reasonable size (i.e., the number of phase shifters is sufficiently small) to facilitate calibration.

Step 2: Note that in the test setup, the antenna is mounted on a precision mechanically rotatable platform and the orientation of the antenna platform is adjusted such that the physical boresight direction of platform is pointed toward the test horn (peaking the array received power from the test horn).

In one embodiment, the corresponding sub-array receive beam and the transmit beam can be obtained from exhaustively searching through all possible AWVs. The number of all possible receive and transmit sub-array AWVs are of reasonable value.

In another embodiment, a search algorithm can be employed to efficiently search through the possible AWVs based on, for example, gradient of the received power as a function of the AWV (hill climbing algorithm). When a given AWV is employed, the corresponding signal strength is recorded. A perturbed AWV is derived to off-point the beam in a slightly different direction and the corresponding signal strength is compared to the previous value to derive the next perturbed direction.

In another embodiment, the AWV of the subarray can be found via geometric direction relative to the antenna plane of the receive subarray and using mathematically derived AWV for that direction. A small region (in solid angle) around the geometric direction can be searched to account for possible hardware implementation imperfection or tolerances. Alternatively, a subset of perturbed AWV from the mathematically derived AWV is used for finding the highest signal strength.

Note that because the size of sub-array is smaller than whole array and the beamwidth of the subarray is wider than the whole array. If there is any small misalignment of transmit or receive beam relative to the mechanical platform direction or between the transmit and receive beam, it would not significantly affect the final formation of the transmit beam for the whole array.

In step 2, all receive subarray beams are aligned with the mechanical platform directions and all subarray transmit beams are aligned with the subarray receive beams based on the above method. Note that the selected subarray AWVs are recorded in a subarray codebook for each subarray. Step 3: Following step 2 approach, a bigger subarray can be calibrated. For example, a bigger sub-array can consist of 16 subarrays in step 2 in 4×4 configuration. For each receive beam of the bigger array, the antenna platform orientation is adjusted to peak the array received power from the test horn (i.e., the receive beam direction points toward the test horn). Note that instead of exhaustively searching all possible AWVs for the bigger array, the subarray beams are adjusted using the subarray AWV only from the codebooks recorded in Step 2. The corresponding transmit beam of the bigger subarray is formed from the combined corresponding transmit sub-array AWV. A quick search among the AWVs from the codebook calibrated transmit subarray in small perturbed direction around the intended direction can be conducted to see if the signal strength of the test horn can be increased. This way the transmit beam of the bigger subarray is calibrated.

Step 4: The process of Step 3 is repeated for incrementally bigger sub-array until the entire array is calibrated.

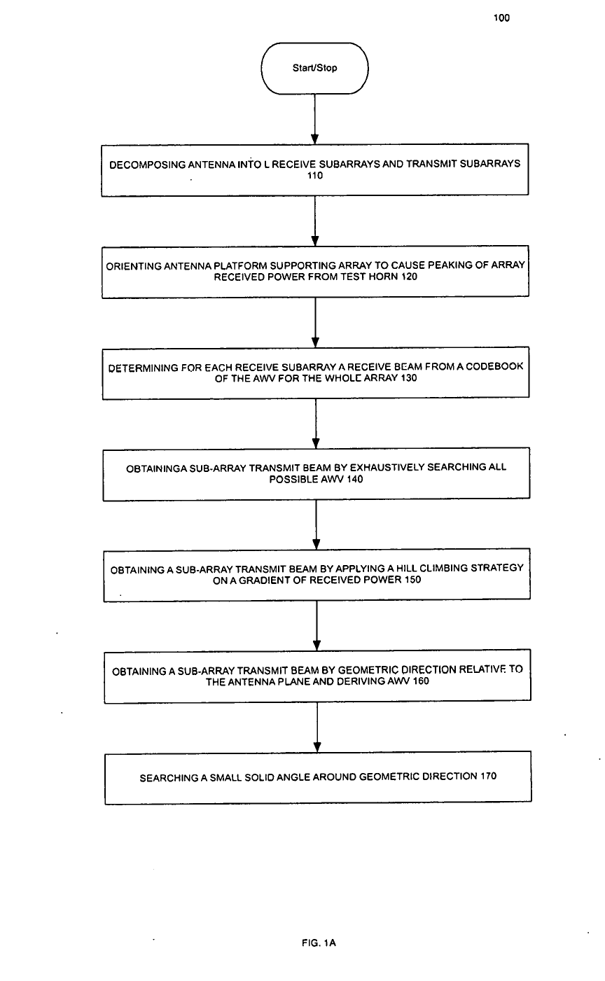

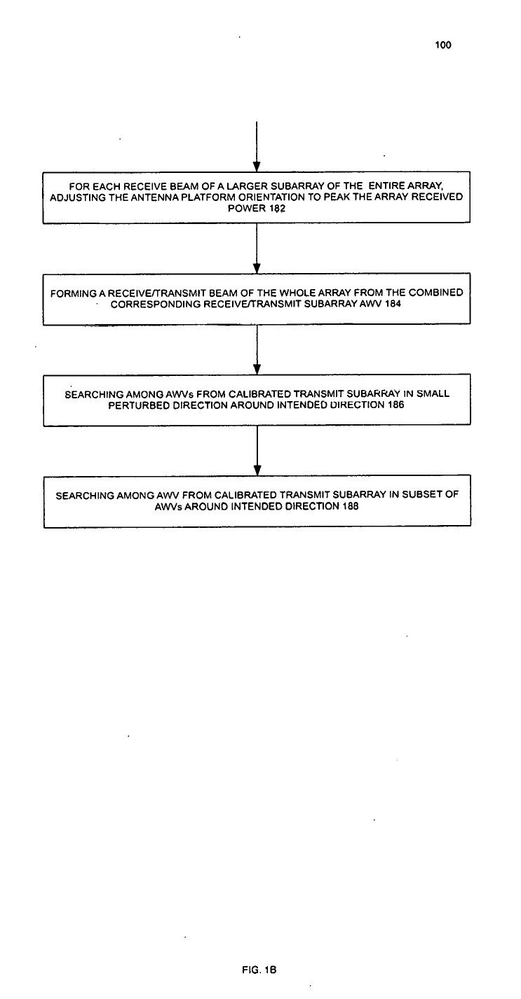

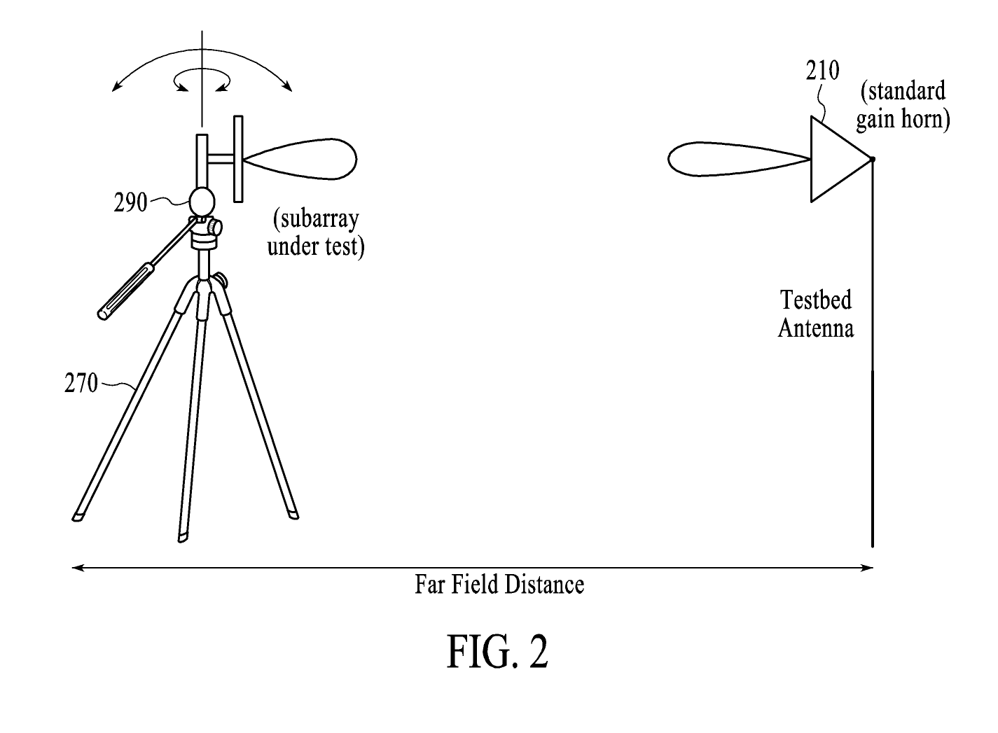

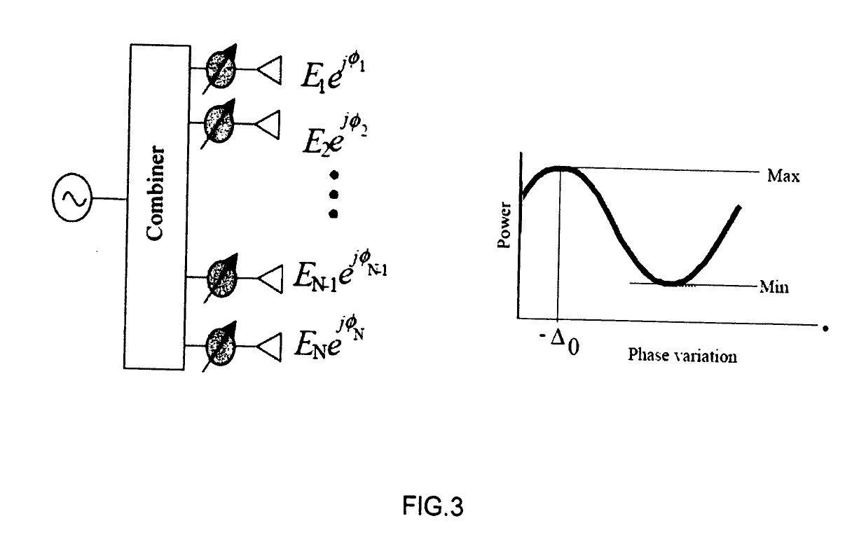

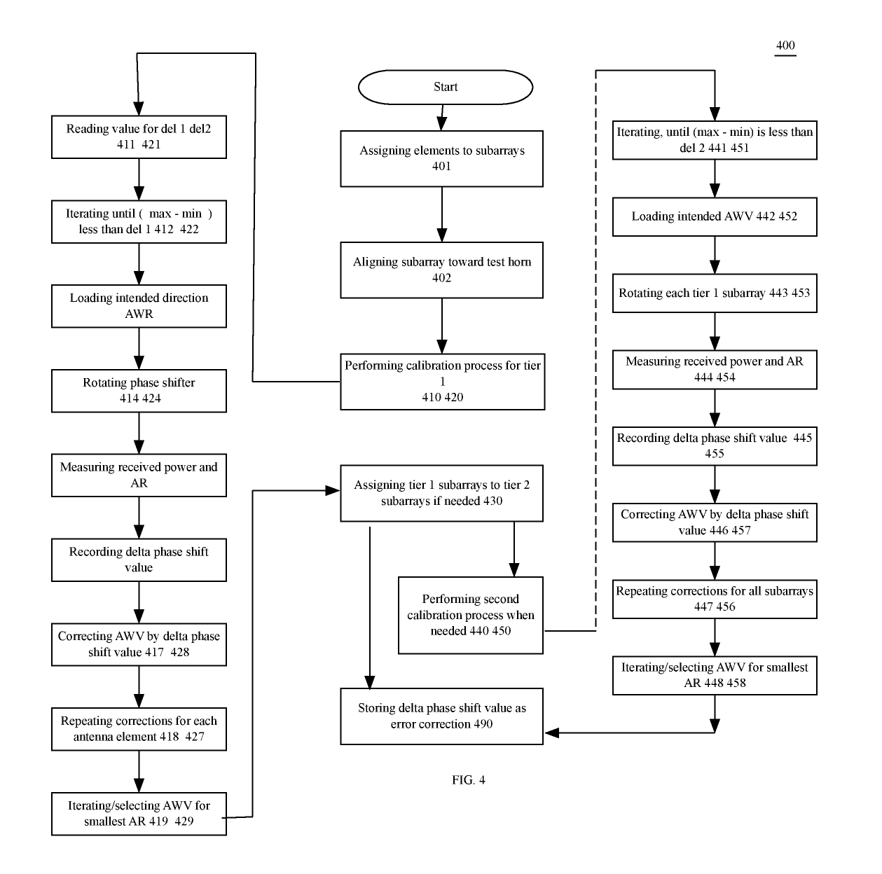

Referring now to the drawings, a method is disclosed in FIGS. 1A and 1B. One aspect of the invention is a process for calibration of antenna weight vectors (AWV) for a large phased-array antenna(antenna), the method including: decomposing an antenna into a plurality (L) of receive subarrays, and an identical plurality of transmit subarrays of equal size 110; orienting an antenna platform supporting the antenna to cause peaking of the array received power from a test horn 120; and determining for each receive sub-array of the L receive sub-arrays, a receive beam from the codebook of the receiver antenna weight vector (AWV) for the whole array 130.

In an embodiment, the method also includes obtaining a sub-array transmit beam by exhaustively searching through all possible AWVs on the condition that the number of all possible transmit sub-array AWVs are reasonable 140.

In an embodiment, the method also includes obtaining a sub-array transmit beam by applying a hill climbing strategy on a gradient of the received power as a function of the AWV in an optimized search 150.

In an embodiment, the method also includes obtaining a sub-array transmit beam by geometric direction relative to the antenna plane of the receive subarray and using mathematically derived AWV for that direction 160.

In an embodiment, the method also includes searching a small solid angle around the geometric direction to account for possible hardware implementation imperfection or tolerances 170.

In an embodiment, all subarray transmit beams are aligned with the subarray receive beams.

In an embodiment, the method also includes for each receive beam of a larger subarray of the entire array, adjusting the antenna platform orientation to peak the array received power from the test horn 182; and forming a receive/transmit beam of the whole array from the combined corresponding receive/transmit sub-array AWV 184.

In an embodiment, the method also includes searching among the AWVs from the calibrated transmit subarray in small perturbed direction around the intended direction to increase the received signal strength of the test horn 186.

In an embodiment, the method also includes searching among the AWVs from the calibrated transmit subarray in subset of AWVs around intended direction to select values which are associated with the lowest axial ratio 188.

One embodiment of the invention is a stack of ceramic or organic dielectric substrates which have conductive film and filled holes. A planar antenna array has multiple ground planes to optimize operation at more than one frequency.

Phased-array elements are isolated by a conductive wall (that can be approximated by a plurality of conductive vias) in a multi-layer substrate.

One aspect of the invention is an article of manufacture for a multiple band planar phased-array antenna system comprising a plurality of substrate strata: a delta strata includes a substrate of thickness proportional to a difference between a first wavelength of a first signal operating at a first frequency and a second wavelength of a second signal operating at a second frequency; a plurality of conductive walls isolating electromagnetic fields of a first signal from electromagnetic fields of a second frequency; a plurality of signal carrying leads of the first signal; a plurality of signal carrying leads of the second signal; and a film of radio frequency (rf) conductive material applied to an upper most surface of the substrate material orthogonal to the leads and conductive walls, partitioned to a plurality of areas above and coupled to each signal carrying lead and a plurality of areas bounded by each conductive wall with an opening surrounding the film above signal carrying leads of the first signal, wherein the conductive walls and the area bounded by the conductive walls are grounded with respect to the first signal.

In an example the article of manufacture also has a topmost strata including a substrate of thickness proportional to a first wavelength of a first signal operating at a first frequency; a plurality of conductive walls embedded into the substrate isolating electromagnetic fields of a first signal from electromagnetic fields of a second frequency; a plurality of signal carrying leads of the first signal embedded into the substrate; a plurality of signal carrying leads of the second signal embedded into the substrate; and a film of rf conductive material applied to an upper most surface of the substrate material orthogonal to the leads and conductive walls, partitioned to a plurality of antenna patches coupled to each signal carrying lead and a plurality of hollow areas above each conductive wall isolating the electromagnetic fields of the first signal from the electromagnetic fields of the second signal wherein the conductive walls and the hollow area above the conductive walls are grounded with respect to the first signal.

In an example, the article of manufacture also has a base strata which includes substrate material intended to be separated from the antenna patches when assembled by a distance proportional to a second wavelength of a second signal operating at a second frequency; a plurality of conductive walls isolating electromagnetic fields of a first signal from electromagnetic fields of a second frequency; a plurality of signal carrying leads of the first signal; a plurality of signal carrying leads of the second signal; and a film of rf conductive material applied to an upper most surface of the substrate material orthogonal to the leads and conductive walls, partitioned to a plurality of areas above and coupled to each signal carrying lead and an area with perforations surrounding the film above each signal carrying lead, wherein the conductive walls and the perforated area are grounded with respect to the first signal and second signal.

In an example, the area bounded by each conductive wall with an opening surrounding the film above signal carrying leads of the first signal is an annulus with inner radius substantially equal to but fractionally greater than the diameter of each signal carrying lead.

Orthogonal polarization of antenna patches further improve signal discrimination.

Below the surface layer, another metal wall isolates each quadrature hybrid.

One aspect of the invention is a dual-band phased-array which consists of a planar array of square patch antennas on either ceramic or organic substrate.
For each unit cell, two patches of different sizes are responsible for transmitting and receiving signals at different frequencies. The patches can be microstrip fed, probe (via) fed, or slot-coupled structures.

The unit cell employs stacked-up topology where multiple layers of dielectric materials are used.

As shown in FIG. 2, the test apparatus includes a standard gain horn as a testbed antenna. Separated by a far field distance is a mechanically rotatable jig on which the subarray under test is attached.

As is known, FIG. 3 demonstrates that by rotating the phase shift of each element, a min and max ratio and angle to achieve max power can be measured. The phase error of each individual antenna element is the phase shift when maximum power is measured. This is stored.

Another aspect of the invention is a method for calibrating and manufacturing a phased-array antenna including: transmitting a test signal from a test antenna horn to a phased-array antenna under test; partitioning a plurality of antenna elements of the phased-array antenna into a plurality of stagel subarrays; transmitting a test signal from a test antenna horn; at each stagel subarray, performing AR-enhanced REV-calibration; grouping stagel subarrays into a plurality of stage2 subarrays on the condition that the phased-array antenna has more than a level1 of antenna elements; at each stage2 subarray, performing AR-enhanced REV-calibration; grouping stage 2 subarrays into a plurality of stage 3 subarrays on the condition that the phased-array antenna has more than a level2 of antenna elements; at each stage3 subarray, performing AR-enhanced REV-calibration; writing into non-transitory storage Phase error values determined by AR-enhanced REV-calibration, and transmitting a test signal from the phased-array antenna to the test antenna horn.

Referring now to FIG. 4 a method flowchart illustrates the processes for a calibration method for a phased-array antenna under test (AuT) including: assigning a plurality (n1) of antenna elements to one of N tier 1 subarrays 401; mechanically aligning each subarray toward a test horn for each of L beam steering angles for each calibration process 402; performing a first calibration process for each of N tier 1 subarrays 410 420; and storing a Δ phase shift value as an error correction value for each AWV into non-transitory storage of the phased array antenna 490.

In an embodiment performing a first calibration process for each of N tier 1 subarray comprises steps following: for each of N subarray, reading a value for δ1 411; iterating, until (maximum received power-minimum received) averaged over n1 is less than δ1 412, loading an intended beam steering direction Antenna Weight Vector (AWV) 413; rotating a phase shifter of kth antenna element within the subarray by increment 0 to 180 degree in pre-determined steps 414; measuring the corresponding received power and antenna axial ratio 415; recording the Δ phase shift value corresponding to the maximum received power 416; correcting AWV by the recorded Δ phase shift value corresponding to the maximum received power for kth antenna element within the subarray 417; repeating corrections for each antenna element 418; iterating and selecting the AWV which gives the smallest axial ratio (AR) as the AWV for each beam direction θj 419.

In an embodiment, performing a first calibration process for each of N tier 1 subarray includes: for each of N subarrays, reading a value for δ1 421; iterating, until (maximum received power-minimum received) averaged over n1 is less than δ1 422; loading an intended beam steering direction Antenna Weight Vector (AWV) 423; rotating a phase shifter of kth antenna element within the subarray by increment 0 to 180 degree in pre-determined steps 424; measuring the corresponding received power and antenna axial ratio 425; recording the Δ phase shift value corresponding to the maximum received power 426; repeating measuring and recording for each antenna element 427; correcting AWV by the record Δ phase shift value corresponding to the maximum received power for all k antenna elements within the subarray 428; iterating and selecting the AWV which gives the smallest axial ratio (AR) as the AWV for each beam direction θj 429.

In an embodiment, the method also includes: on the condition that the quantity of antenna elements exceeds a first threshold, assigning a second plurality (n2) of tier 1 subarrays to each of M tier2 subarrays 430; and performing a second calibration process for each of M tier 2 subarrays 440 450.

In an embodiment, performing a second calibration process for each of M tier 2 subarray includes for each of M tier 2 subarrays, iterating, until (maximum received power-minimum received) averaged over n2 subarrays is less than δ2 441; loading initial AWV for intended beam steering direction 442; rotating each phase shifter of kth tier 1 subarray with all antenna element with the subarray rotate the same amount of phase shift by increment 0 to 180 degree in pre-determined step 443; measuring the corresponding received power and antenna axial ratio 444; recording the Δ phase shift value corresponding to the maximum received power 445; correcting AWV of all antenna elements in kth subarray by the record Δ phase shift value corresponding to the maximum received power for each tier 1 subarray within the tier 2 subarray 446; repeating corrections for all tier 1 subarray 447; and iterating to select the AWV which gives the smallest AR as the AWV for each beam direction θj 448.

In an embodiment, performing a second calibration process for each of M tier 2 subarray includes: for each of M tier 2 subarrays, iterating, until (maximum received power-minimum received) averaged over n2 subarrays is less than δ2 451; loading an initial AWV for intended beam steering direction 452; rotating phase shifter of kth tier 1 subarray with all antenna element with the subarray rotated the same amount of phase shift by increment 0 to 180 degree in pre-determined steps 453; measuring the corresponding received power and antenna axial ratio 454; recording the Δ phase shift value corresponding to the maximum received power 455; repeating the preceding step for each tier 1 subarray 456; correcting AWV of all antenna elements in all subarrays by the recorded Δ phase shift value corresponding to the maximum received power for each tier 1 subarray within the tier 2 subarray 457; and interating to select the AWV which gives the smallest AR as the AWV for each beam direction θj 458.

In an embodiment, the method also includes on the condition that the quantity of antenna elements exceeds a second threshold: decomposing an array into a plurality of tier T hierarchical subarrays composed of tier T-1 hierarchical subarrays.

In an embodiment, the AuT is a transmission antenna and measurements are performed at the test horn.

In an embodiment, the AuT is a receive antenna and measurements are performed on signals emitted by the test horn.

### Conclusion

Thus it can be appreciated that the invention is easily distinguished from conventional phased-array antenna calibration methods. When each phase shifter has 2̂k steps (a k-bit phase shifter), the number of possible AWVs would be 2̂k*n). A brute-force calibration going through 2̂k*n) AWVs can take extremely long time.

When the number of elements in a subarray exceeds a certain size, it becomes challenging to determine an accurate optimal set of phase shift values by relying on a conventional REV methodology.

The invention improves calibration, making it practical and economic for large arrays, and provides a long sought exit mechanism when REV calibration thrashing is encountered.

A number of embodiments of the invention have been described. Nevertheless, it will be understood that various modifications may be made without departing from the spirit and scope of the invention. Accordingly, other embodiments are within the scope of the following claims.

1. A phased-array antenna calibration, manufacture, and test apparatus comprises:
a test antenna (horn) coupled to a 1st radio-frequency transceiver,
the transceiver coupled to a 1st power level instrument,
the 1^{st} power level instrument coupled to a computing device;
the computing device further coupled to an antenna weight vector programming device,
the programming device further coupled to a phased-array antenna test fixture;
the test fixture further coupled to a 2nd radio-frequency transceiver and to
a 2nd power level instrument.

2. The test apparatus of claim 1 wherein
the test antenna is one of a pre-calibrated linear polarized horn antenna and a circular polarized horn antenna according to the polarization of the antenna under test; and
said test antenna is mounted to a rotational pivot whereby an antenna axial ratio can be observed by comparing measurements when the horn antenna is rotated from 0 to at least 180 degree (for single polarization) or with a dual polarization test horn antenna containing dual-polarization ports.

3. A method for calibration of an array and its subarrays comprising:
treating each subarray (pre-calibrated in itself in previous step) in the same fashion as equivalent to an antenna element in the subarray calibration by
rotating all elements in subarray by the same phase shift value from 0 to 360 degree during the full array calibration;
recording received power at a test horn as a function of the subarray phase shift; and
storing the phase shift value at the maximum power level as the phase shift error for a component;
wherein a component is one of a second tier subarray and an antenna element of a first tier subarray.

4. The method of claim 3 further comprising:
applying REV method for the whole array until phase shift values are converged within a range and the power variation in an iteration is small;
measuring antenna axial ratio (AR) of the whole array in the subsequent iterations;
selecting an AWV having the best axial ratio as the results of the calibration to improve the resolution of the REV method;
whereby the resolution of the phase shifter values is more accurate over the REV method alone.

5. A process for transmission calibration and manufacture of an Antenna under Test (AuT) comprising:
Step 1: Break up array into N tier 1 subarray, each tier 1 subarray with nl antenna element (e.g., n1=16, arrange in 4×4 consecutive element configuration). Note that the number of antenna elements in the tier 1 subarray should be<a predetermined number
Step 2 for one beam steering angle θj, j belongs in {0, 1, . . . , (L-1) } (Note θj can be in azimuth or elevation direction), for each j, rotating AuT platform such that beam propagation steering direction points toward test horn
Step 3 Calibrating of N subarrays by
Step 3.1 for subarrayi, i=0, 1, . . . , (N-1)
Step 3.1.1 Perform a few iterations of the following steps until (maximum received power-minimum received) averaged over n1 of Step 2.1.2.3 is less than δ1:
Step 3.1.1.1: Loading AWV for intended beam steering direction (start with initial AWV);
Step 3.1.1.2: Rotate phase shifter of kth antenna element within the subarray by increment 0 to 180 degree in pre-determined step, and measure the corresponding received power and antenna axial ratio, recording the Δ phase shift value corresponding to the maximum received power at the test horn;
Step 3.1.1.3 Repeating the preceding step for k=0, 1, . . . , (n1-1) antenna element;
Step 3.1.1.4 Correcting AWV by the recorded Δ phase shift values corresponding to the maximum received power for all antenna elements within the subarray;
Step 3.1.2 Continue Step 2.1.2 for a few iterations and select the AWV which gives the smallest AR as the AWV for beam direction θj.

6. The process of claim 5 further comprising:
Step 4 Breaking up array into M tier 2 subarrays, each tier 2 subarray contains with n2 of tier 1 subarrays (e.g., n2=16, arrange in 4×4 consecutive tier 1 subarray configuration); wherein the number of tier 1 subarrays within tier 2 subarray should be less than a predetermined number;
Step 5 Calibrating of M tier 2 subarrays by Step 5.1 for tier 2 subarrayi, i=0, 1, . . . , (M-1)
Step 5.1.1 Performing a few iterations of the following steps until (maximum received power-minimum received) averaged over n2 of Step 2.1.2.3 is less than δ2:
Step 5.1.1.1: Loading AWV for intended beam steering direction (start with initial AWV);
Step 5.1.1.2: loading phase shifter store of kth tier 1 subarray with all antenna element with the subarray by the same amount of phase shift by increment 0 to 180 degree in pre-determined step, and measuring the corresponding received power and antenna axial ratio, recording the Δ phase shift value corresponding to the maximum received power;
Step 5.1.1.3 Repeating the preceding step for k=0, 1, . . . , (n2-1) tier 1 subarray;
Step 5.1.1.4 Correcting AWV of all antenna elements in all subarrays by the recorded Δ phase shift value corresponding to the maximum received power for each tier 1 subarray within the tier 2 subarray;
Step 5.1.2 Continuing Step 4.1.2 for a few iterations and storing the AWV which gives the smallest AR as the AWV for beam direction θj.

7. The method of claim 6 further comprising:
Step 6 When the number of tier x subarrays within tier x+1 subarray exceeds a predetermined number, Continuing to break up array into tier x+2 subarrays, if necessary and repeating Step 3 to 5 to calibrate x+1 tier subarrays;
Repeating Step 3 to Step 6 for other θj's.

8. A method for transmission testing a phased-array Antenna under Test (AuT) comprising:
Step 1: Assigning elements of the array into N tier 1 subarrays, each tier 1 subarray with n1 antenna element wherein the number of antenna elements in the tier 1 subarray should be less than a predetermined number;
Step 2 for one beam steering angle θj, j belongs in {0, 1, . . . , (L-1) } wherein θj can be in azimuth or elevation direction, for each j, rotating AuT platform such that beam steering direction points toward test horn;
Step 3 Calibrating N subarrays by
Step 3.1 for subarrayi, i=0, 1, . . . , (N-1)
Step 3.1.1 performing a few iterations of the following steps until (maximum received power-minimum received) averaged over n1 of Step 2.1.2.3 is less than δ1:
Step 3.1.1.1: Loading AWV for intended beam steering direction (start with initial AWV);
Step 3.1.1.2: loading phase shifter store of kth antenna element within the subarray by increment 0 to 180 degree in pre-determined step, and measuring the corresponding received power and antenna axial ratio, recording the Δ phase shift value corresponding to the maximum received power;
Step 3.1.1.3 correcting AWV by the record Δ phase shift value corresponding to the maximum received power for kth antenna element within the subarray; and
Step 3.1.1.4 repeating the preceding step for k=0, 1, . . . , (n1-1) antenna element;
Step 3.1.2 continuing Step 2.1.2 for a few iterations and storing the AWV which gives the smallest AR as the AWV for beam direction θj.

9. The method of claim 8 further comprising:
Step 4 assigning elements of the array into M tier 2 subarrays, each tier 2 subarray contains with n2 of tier 1 subarrays wherein the number of tier 1 subarrays within tier 2 subarray should be less than a predetermined number;
Step 5 calibrating M tier 2 subarrays by Step 5.1 for tier 2 subarrayi, i=0, 1, . . . (M-1)
Step 5.1 performing a few iterations of the following steps until (maximum received power-minimum received) averaged over n2 of Step 2.1.2.3 is less than δ2 :
Step 5.1.1.1: loading AWV for intended beam steering direction (start with initial AWV);
Step 5.1.1.2: loading phase shifter store of kth tier 1 subarray with all antenna element with the same amount of phase shift by increment 0 to 180 degree in pre-determined step, and measuring the corresponding received power and antenna axial ratio, recording the Δ phase shift value corresponding to the maximum received power;
Step 5.1.1.3 correcting AWV of all antenna elements in kth subarray by the record Δ phase shift value corresponding to the maximum received power for each tier 1 subarray within the tier 2 subarray;
Step 5.1.1.4 repeating the preceding step for k=0, 1, . . . , (n2-1) tier 1 subarray;
Step 5.1.2 continuing Step 4.1.2 for a few iterations and storing the AWV which gives the smallest AR as the AWV for beam direction θj.

10. The method of claim 9 further comprising:
Step 6 when the number of tier x subarrays within tier x+1 subarray exceeds a predetermined number,
continuing to break up array into tier x+2 subarrays, if necessary and repeat Step 3 to 5 to calibrate x+1 tier subarrays; and
repeating Step 3 to Step 6 for other θj's.

11. A method for calibrating and manufacturing a phased-array antenna comprising:
transmitting a test signal from a test antenna horn to a phased-array antenna under test;
partitioning a plurality of antenna elements of the phased-array antenna into a plurality of stagel subarrays;
transmitting a test signal from a test antenna horn;
at each stagel subarray, performing AR-enhanced REV-calibration;
grouping stagel subarrays into a plurality of stage2 subarrays on the condition that the phased-array antenna has more than a level1 of antenna elements;
at each stage2 subarray, performing AR-enhanced REV-calibration;
grouping stage 2 subarrays into a plurality of stage 3 subarrays on the condition that the phased-array antenna has more than a level2 of antenna elements;
at each stage3 subarray, performing AR-enhanced REV-calibration;
writing into non-transitory storage Phase error values determined by AR-enhanced REV-calibration, and
transmitting a test signal from the phased-array antenna to the test antenna horn.

12. The method of claim 11 wherein AR-enhanced REV-calibration comprises:
applying REV-method calibration to each element of the stagel subarray repetitiously until received power level measurements begins to cease improving on each iteration;
upon determining that received power level at the stagel subarray has started wandering, initiating axial ratio (AR) selection for each REV-method calibration; and
storing an antenna weight value resulting from REV-method calibration having best AR into a store for each stagel subarray.

13. The method of claim 12 wherein REV-calibration comprises:
varying the phase of each individual antenna element from 0 to 360 degree while,
recording the power received in the gain horn as a function of phase shifter values for transmit array calibration;
recording the power received by the antenna under test as a function of the phase shifter values for receive array calibration; and
finding phase and amplitude error of element I corresponding to maximum power;
calibrating each subarray with REV method described for a given beam direction;
rotating phase shift of each antenna element from 0 to 360 degree to find the max power and recording the corresponding phase shift; and,
updating the phase shift values of all antenna elements.

14. A method to calibrate antenna weight vectors for a large phased-array antenna(antenna), the method comprising:
decomposing the antenna into a plurality (L) of receive subarrays, and an identical plurality of transmit subarrays of equal size;
orienting an antenna platform supporting the large array to cause peaking of the array received power from a test horn; and
determining for each receive sub-array of the L receive sub-arrays, a receive beam from the codebook of the receiver antenna weight vector (AWV) for the whole array.

15. The method of claim 14 further comprising:
obtaining a sub-array transmit beam by exhaustively searching through all possible AWVs on the condition that number of all possible transmit sub-array AWVs are reasonable.

16. The method of claim 14 further comprising:
obtaining a sub-array transmit beam by applying a hill climbing strategy on a gradient of the received power as a function of the AWV in an optimized search.

17. The method of claim 14 further comprising
obtaining a sub-array transmit beam by geometric direction relative to the antenna plane of the receive subarray and using mathematically derived AWV for that direction.

18. The method of claim 14 further comprising:
searching a small solid angle around the geometric direction to account for possible hardware implementation imperfection or tolerances.

19. The method of claim 14 further comprising:
for each receive beam of a larger subarray of the entire array, adjusting the antenna platform orientation to peak the array received power from the test horn; and
forming a receive/transmit beam of the whole array from the combined corresponding receive/transmit sub-array AWV.

20. The method of claim 19 further comprising:
searching among the AWVs from the calibrated transmit subarray in small perturbed direction around the intended direction to minimize the axial ratio.

21. A calibration method for a phased-array antenna under test (AuT) comprising:
assigning a plurality (n1) of antenna elements to one of N tier 1 subarrays;
mechanically aligning each subarray toward a test horn for each of L beam steering angles for each calibration process;
performing a first calibration process for each of N tier 1 subarrays; and
storing a Δ phase shift value as an error correction value for each AWV into non-transitory storage of the phased array antenna.

22. The method of claim 21 wherein performing a first calibration process for each of N tier 1 subarray comprises steps following:
for each of N subarrays,
reading a value for δ1;
iterating, until (maximum received power-minimum received) averaged over nl is less than δ1,
loading an intended beam steering direction Antenna Weight Vector (AWV);
rotating a phase shifter of kth antenna element within the subarray by increment 0 to 180 degree in pre-determined steps;
measuring the corresponding received power and antenna axial ratio;
recording the Δ phase shift value corresponding to the maximum received power;
correcting AWV by the recorded Δ phase shift value corresponding to the maximum received power for kth antenna element within the subarray;
repeating corrections for each antenna element;
iterating and selecting the AWV which gives the smallest axial ratio (AR) as the AWV for each beam direction θj.

23. The method of claim 21 wherein performing a first calibration process for each of N tier 1 subarray comprises steps following:
for each of N subarrays,
reading a value for δ1;
iterating, until (maximum received power-minimum received) averaged over n1 is less than δ1,
loading an intended beam steering direction Antenna Weight Vector (AWV);
rotating a phase shifter of kth antenna element within the subarray by increment 0 to 180 degree in pre-determined steps;
measuring the corresponding received power and antenna axial ratio;
recording the Δ phase shift value corresponding to the maximum received power;
repeating measuring and recording for each antenna element;
correcting AWV by the record Δ phase shift value corresponding to the maximum received power for all k antenna elements within the subarray;
iterating and selecting the AWV which gives the smallest axial ratio (AR) as the AWV for each beam direction θj.

24. The method of claim 21 further comprising:
on the condition that the quantity of antenna elements exceeds a first threshold,
assigning a second plurality (n2) of tier 1 subarrays to each of M tier2 subarrays; and
performing a second calibration process for each of M tier 2 subarrays.

25. The method of claim 24 wherein performing a second calibration process for each of M tier 2 subarray comprises steps following:
for each of M tier 2 subarrays,
iterating, until (maximum received power-minimum received) averaged over n2 subarrays is less than δ2;
loading initial AWV for intended beam steering direction;
rotating each phase shifter of kth tier 1 subarray with all antenna element with the subarray rotate the same amount of phase shift by increment 0 to 180 degree in pre-determined step;
measuring the corresponding received power and antenna axial ratio;
recording the Δ phase shift value corresponding to the maximum received power;
correcting AWV of all antenna elements in kth subarray by the record Δ phase shift value corresponding to the maximum received power for each tier 1 subarray within the tier 2 subarray;
repeating corrections for all tier 1 subarray; and
iterating to select the AWV which gives the smallest AR as the AWV for each beam direction θj.

26. The method of claim 24 wherein performing a second calibration process for each of M tier 2 subarray comprises steps following:
for each of M tier 2 subarrays,
iterating, until (maximum received power-minimum received) averaged over n2 subarrays is less than δ2;
loading an initial AWV for intended beam steering direction;
rotating phase shifter of kth tier 1 subarray with all antenna element with the subarray rotated the same amount of phase shift by increment 0 to 180 degree in pre-determined steps;
measuring the corresponding received power and antenna axial ratio;
recording the Δ phase shift value corresponding to the maximum received power;
repeating the preceding step for each tier 1 subarray;
correcting AWV of all antenna elements in all subarrays by the recorded Δ phase shift value corresponding to the maximum received power for each tier 1 subarray within the tier 2 subarray; and
interating to select the AWV which gives the smallest AR as the AWV for each beam direction θj.

27. The method of claim 24 further comprising on the condition that the quantity of antenna elements exceeds a second threshold:
decomposing an array into a plurality of tier T hierarchical subarrays composed of tier T-1 hierarchical subarrays.

28. The method of claim 21 wherein the AuT is a transmission antenna and measurements are performed at the test horn.

29. The method of claim 21 wherein the AuT is a receive antenna and measurements are performed on signals emitted by the test horn.
